(19) United States
(12) Patent Application Publication
(10) Pub. No.: US 2010/0242062 A1
(43) Pub. Date: Sep. 23, 2010

(54) METHOD AND APPARATUS FOR AUTHENTICATING A PLURALITY OF MEDIA DEVICES SIMULTANEOUSLY

(75) Inventors: ANTHONY REYNOLDS, Oak Lawn, IL (US); Daniel P. Malee, Wheaton, IL (US)

Correspondence Address: AT&T Legal Department - GMG;Attn: Patent Docketing, Room 2A-207, One AT&T Way, Bedminster, NJ, 07921, US

(73) Assignee: AT&T INTELLECTUAL PROPERTY I, LP., Reno, NV (US)

(21) Appl. No.: 12/409,266

(22) Filed: Mar. 23, 2009

(51) Int. Cl. H04N 7/16

(52) U.S. Cl. 725/25

(57) ABSTRACT

A system that incorporates teachings of the present disclosure may include, for example, a web server, comprising a controller to receive a request for authentication from a plurality of set-top boxes operating in an Internet Protocol Television (IPTV) system via a service enablement device; authenticate the plurality of set-top boxes using a remote authentication dial in user service (RADIUS); and enable service to the plurality of set-top boxes based on the authentication using the RADIUS. Other embodiments are disclosed.

### FIELD OF THE DISCLOSURE

The present disclosure relates generally to authentication of media devices and more specifically to a method and apparatus for authenticating a plurality of media devices simultaneously.

### BACKGROUND

As advances in technology have dramatically risen in recent years, consumers can now enjoy media content through a variety of means. Consumers can experience media content through analog and digital televisions, set-top boxes, Internet Protocol Television (IPTV) systems, satellite television systems, cable systems, and other media systems. The media broadcast through such systems can include audio, video, text, and/or images or combinations thereof.

Today's consumer demands a reliable and consistent video service when subscribing to, for example, an interactive TV service. Any degradation or interruption in the video service causes much aggravation and also always runs the risk of losing customers in a competitive market place. When a video service is temporarily interrupted due to, for example but not limited to, a power outage, it is necessary to secure and authenticate the video devices when power is again restored, without any interruption or degradation in service. The previous solution utilized web services only, which was slow and prone to over utilization.

As an example, in 2008, the city of Houston, Tex. experienced a massive power outage. The slow speed of processing of web server to web server (i.e., four set-top boxes per second) resulted in an unacceptable delay of a day and a half to bring customers of the interactive TV service back on line, etc.

### BRIEF DESCRIPTION OF THE DRAWINGS

FIGS. 1-2 depict illustrative embodiments of communication systems that provide media services;

FIG. 3 depicts an illustrative embodiment of a portal interacting with the communication systems of FIGS. 1-2;

FIG. 4 depicts an illustrative embodiment of a communication device utilized in the communication systems of FIGS. 1-2;

FIG. 5 depicts an illustrative embodiment of a system for authenticating a plurality of media devices simultaneously;

FIG. 6 depicts an illustrative embodiment of a method operating in portions of the communication systems of FIGS. 1-2; and

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail in a web server, a method, comprising: requesting authentication for a plurality of video media devices operating in an interactive TV (iTV) system after a power outage has occurred in said system; authenticating the plurality of video media devices concurrently using a remote authentication dial in user service (RADIUS); and restoring service to the plurality of video media devices based on the concurrent authentication by the RADIUS.

Another embodiment of the present disclosure can entail a web server, comprising a controller to: receive a request for authentication from a plurality of set-top boxes operating in an Internet Protocol Television (IPTV) via a service enablement device; authenticate the plurality of set-top boxes using a RADIUS; and enable service to the plurality of set-top boxes based on the authentication using the RADIUS.

Yet another embodiment of the present disclosure can entail a remote authentication dial in user service (RADIUS), comprising a controller to: receive requests for authentication from a web server for a plurality of video media devices operating in an interactive media system after conversion of the requests from a simple object access protocol (SOAP) to a user datagram protocol (UDP); and authenticate the requests for the plurality of video media devices concurrently to provide completed requests, thereby enabling service to the plurality of video media devices after conversion of the completed requests from UDP to SOAP.

Another embodiment of the present disclosure can entail a set-top box operating in an interactive TV system, comprising a controller to: send a request for authentication via at least one service enablement device and at least one web server; and obtain authentication for the STB concurrently with other STBs using a RADIUS, wherein the RADIUS enables service to the STB and the plurality of other STBs based on the concurrent authentication using the RADIUS.

A still further embodiment of the present disclosure can entail a computer-readable storage medium, comprising computer instructions to: request authentication for a plurality of set-top boxes via a service enablement bootstrap device; authenticate the plurality of set-top boxes concurrently using a RADIUS; and restore service of an Internet Protocol Television (IPTV) system to the plurality of set-top boxes based on the concurrent authentication using the RADIUS.

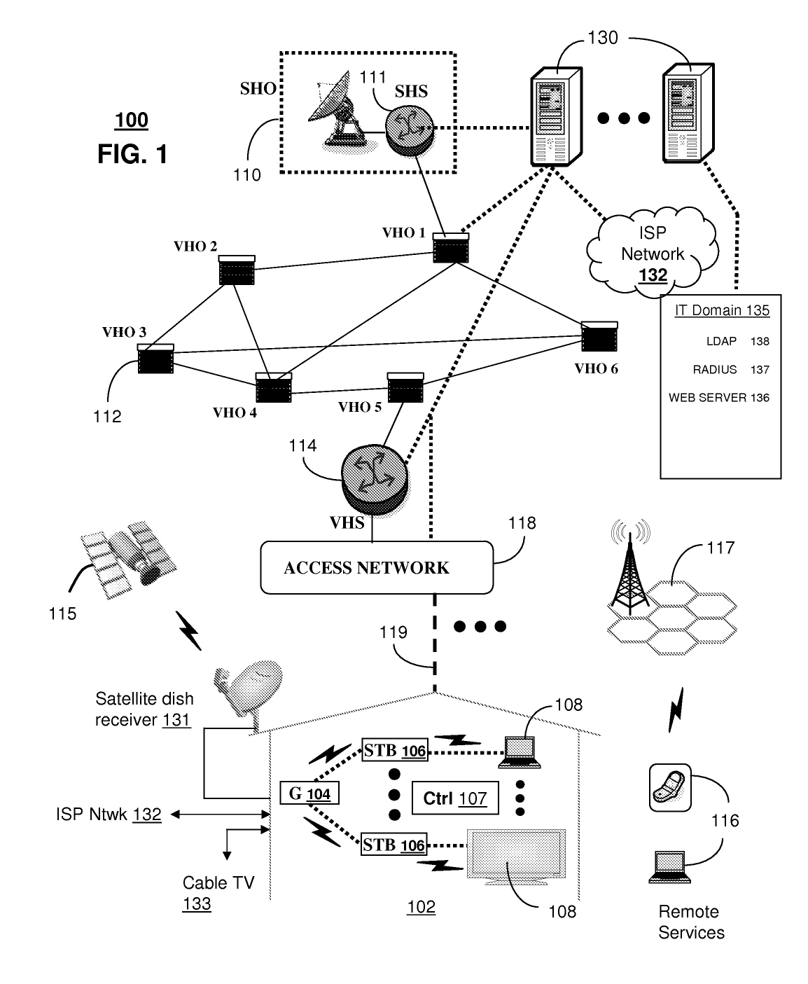

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

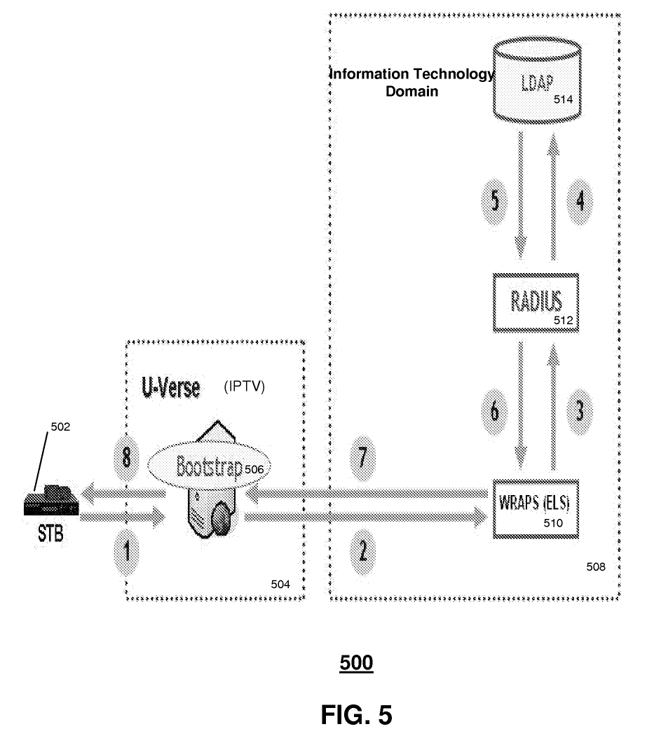

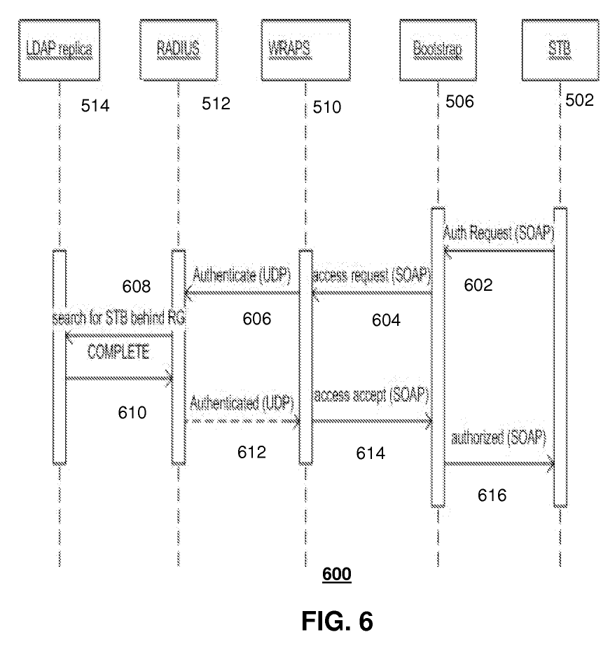

In an embodiment, the communications system 100 can also include an information technology domain 135 comprising a web server 136, a RADIUS 137 and a lightweight directory access protocol (LDAP) 138 which are described in more detail below in connection with FIGS. 5 and 6.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services.

It follows from the above illustrations that the present disclosure can apply to any present or future interactive over-the-air or landline media content services.

FIG. 2 depicts an illustrative embodiment of a communication system 200 employing an IP Multimedia Subsystem (IMS) network architecture to facilitate the combined services of circuit-switched and packet-switched systems. Communication system 200 can be overlaid or operably coupled with communication system 100 as another representative embodiment of communication system 100.

Communication system 200 can comprise a Home Subscriber Server (HSS) 240, a tElephone NUmber Mapping (ENUM) server 230, and other common network elements of an IMS network 250. The IMS network 250 can establish communications between IMS compliant communication devices (CD) 201, 202, Public Switched Telephone Network (PSTN) CDs 203, 205, and combinations thereof by way of a Media Gateway Control Function (MGCF) 220 coupled to a PSTN network 260.

IMS CDs 201, 202 can register with the IMS network 250 by contacting a Proxy Call Session Control Function (P-CSCF) which communicates with a corresponding Serving CSCF (S-CSCF) to register the CDs with at the HSS 240. To initiate a communication session between CDs, an originating IMS CD 201 can submit a Session Initiation Protocol (SIP INVITE) message to an originating P-CSCF 204 which communicates with a corresponding originating S-CSCF 206. The originating S-CSCF 206 can submit queries to the ENUM system 230 to translate an E.164 telephone number in the SIP INVITE to a SIP Uniform Resource Identifier (URI) if the terminating communication device is IMS compliant.

The SIP URI can be used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214. The terminating S-CSCF 214 can then identify a terminating P-CSCF 216 associated with the terminating CD 202. The P-CSCF 216 then signals the CD 202 to establish communications.

If the terminating communication device is instead a PSTN CD such as references 203 or 205, the ENUM system 230 can respond with an unsuccessful address resolution which can cause the originating S-CSCF 206 to forward the call to the MGCF 220 via a Breakout Gateway Control Function (BGCF) 219. The MGCF 220 can then initiate the call to the terminating PSTN CD by common means over the PSTN network 260.

The aforementioned communication process is symmetrical. Accordingly, the terms “originating” and “terminating” in FIG. 2 are interchangeable. It is further noted that communication system 200 can be adapted to support video conferencing by way of common protocols such as H.323. In addition, communication system 200 can be adapted to provide the IMS CDs 201, 203 the multimedia and Internet services of communication system 100.

The computing devices 130 of FIG. 1 can be operably coupled to the second communication system 200 for purposes similar to those described above.

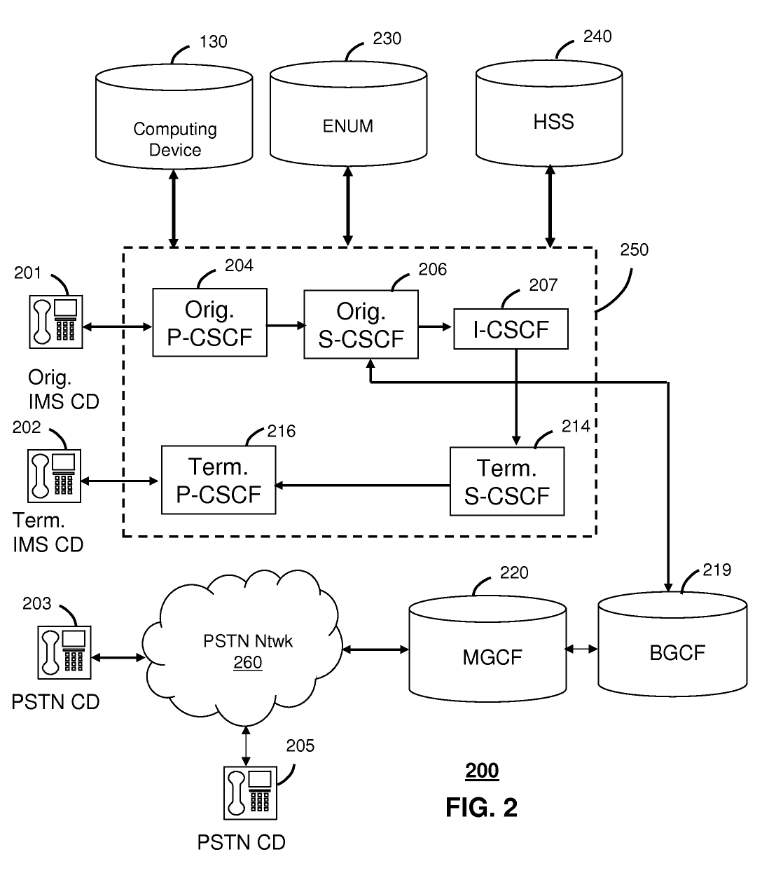

FIG. 3 depicts an illustrative embodiment of a portal 302 which can operate from the computing devices 130 described earlier of communication 100 illustrated in FIG. 1. The portal 302 can be used for managing services of communication systems 100-200. The portal 302 can be accessed by a Uniform Resource Locator (URL) with a common Internet browser such as Microsoft's Internet Explorer™ using an Internet-capable communication device such as those described for FIGS. 1-2. The portal 302 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services described earlier, provisioning Internet services, provisioning cellular phone services, and so on.

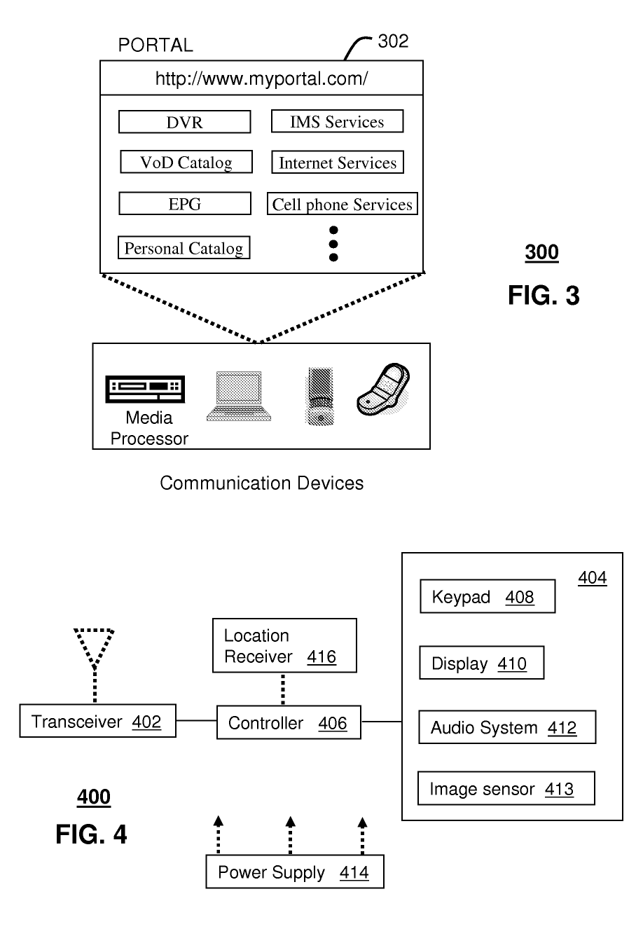

FIG. 4 depicts an exemplary embodiment of a communication device 400. Communication device 400 can serve in whole or in part as an illustrative embodiment of the communication devices of FIGS. 1-2. The communication device 400 can comprise a wireline and/or wireless transceiver 402 (herein transceiver 402), a user interface (UI) 404, a power supply 414, a location receiver 416, and a controller 406 for managing operations thereof. The transceiver 402 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 404 can include a depressible or touch-sensitive keypad 408 with a navigation mechanism such as a roller ball, joystick, mouse, or navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric dialing keypad commonly used by phones, and/or a Qwerty keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display.

The UI 404 can also include an audio system 412 that utilizes common audio technology for conveying low volume audio (such as audio heard only in the proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and charging system technologies for supplying energy to the components of the communication device 400 to facilitate long-range or short-range portable applications. The location receiver 416 can utilize common location technology such as a global positioning system (GPS) receiver for identifying a location of the communication device 400 based on signals generated by a constellation of GPS satellites, thereby facilitating common location services such as navigation.

The communication device 400 can use the transceiver 402 to also determine a proximity to a cellular, WiFi or Bluetooth access point by common power sensing techniques such as utilizing a received signal strength indicator (RSSI) and/or a signal time of arrival (TOA) or time of flight (TOF). The controller 406 can utilize computing technologies such as a microprocessor, a digital signal processor (DSP), and/or a video processor with associated storage memory such a Flash, ROM, RAM, SRAM, DRAM or other storage technologies.

The communication device 400 can be adapted to perform the functions of the media processor 106, the media devices 108, or the portable communication devices 116 of FIG. 1, as well as the IMS CDs 201-202 and PSTN CDs 203-205 of FIG. 2. It will be appreciated that the communication device 400 can also represent other common devices that can operate in communication systems 100-200 of FIGS. 1-2 such as a gaming console and a media player.

FIG. 5 depicts an illustrative embodiment of a system 500 for authenticating a plurality of media devices simultaneously, the system 500 being operable in portions of the communications systems of FIGS. 1 and 2. The system can include one or more set-top boxes 502, which can be configured to deliver media content to a plurality of media devices 108 (see FIG. 1). For ease of understanding, only one set-top box 502 is shown in FIG. 5, although FIG. 1 illustrates multiple set-top boxes 106. The media devices 108 can include any device capable of displaying and/or playing media content such as televisions, cellular phones, personal digital assistants (PDA), computers, and the like.

Additionally, the system 500 can include a bootstrap device 506 which may be part of, for example, an IPTV system 504. The bootstrap device 506 is a service enablement device that begins the initialization of the operating system. The bootstrap device 506 communicates with information technology (IT) domain 508 which can include a web radius authentication proxy service (WRAPS) 510 (also referred to as web server 510), a remote authentication dial in user service (RADIUS) device 512, and a lightweight directory access protocol (LDAP) device 514.

The WRAPS 510 may comprise an external login system which is configured to connect, for example, the IPTV system 504 with one or more set-top boxes 502 which are requesting authentication using RADIUS technology of the RADIUS device 512.

In general, RADIUS is a networking protocol that provides centralized access, authorization and accounting management for people or computers to connect and use a network service. When a person or device connects to a network, authentication is required. RADIUS based systems have been used by telephone companies to identify their customers. Once authenticated, RADIUS also can determine what rights or privileges the person or computer is authorized to perform and makes a record of this access in the accounting feature of the server. The support of authentication, authorization and accounting is referred to as the AAA process.

In operation, a RADIUS access request message is sent to the RADIUS device 512 requesting authorization to grant access via the RADIUS protocol. This access request may include access credentials, for example, in the form of username and password or security certificate provided by the user or client device, which in this case may be one or more set-top boxes 502. Additionally, the request contains information that the WRAPS server 510 knows about the client device, such as its network address or phone number, and information regarding the users physical point of attachment to the WRAPS server 510. The RADIUS device 512 then checks the client device's information against a file database such as LDAP device 514 to verify the client device's credentials. In this regard, note that LDAP device 514 can be an internet protocol that RADIUS device 512 uses to look up information from a server. In general, LDAP servers index all the data in their entries, and filters may be used to select just the person or group which is desired, and return just the information desired. For example, an LDAP search may be as follows: “Search for all people located in Houston whose name contains “Doe” that have an e-mail address. Please return their full name, e-mail, title, and description.”

FIG. 6 depicts an illustrative method 600 that operates in portions of the communication systems of FIGS. 1 and 2. Method 600 can begin with step 602 in which an authentication request is received for one or more set-top boxes 502 using simple object access protocol (SOAP) at the bootstrap device 506. From bootstrap device 506, access is requested in step 604 again using SOAP to WRAPS 510. In step 606, each request is then converted from SOAP to user datagram protocol (UDP) packets for authentication by the RADIUS device 512. The RADIUS device 512 then searches for the particular STB 502 in LDPA device 514. The RADIUS device 512 then may return a response of: “access reject” or “access accept”. It is also possible to return a response of “access challenge”.

In step 610, the checking of information by the RADIUS device 512 is completed, and assuming an “access accept”, the STB 502 is authenticated in step 612 in the form of UDP packets, and access is granted in step 614 and converted back to SOAP, and then the STB 502 is authorized in step 616.

The present system/methodology is operative to rapidly secure and authenticate thousands of, for example, video media devices such as set-top boxes concurrently after, for example, a power outage has occurred. After a major power outage has occurred, whether due to natural causes or man made causes, it is desired to provide rapid and secure authentication concurrently in order to provide subscribers of, for example but not limited to, IPTV, with immediate service without any interruption or degradation in service. As mentioned above in the Background section, the previous solution utilized web services only, which was slow and prone to over utilization. The present system/methodology remarkably improves upon the previous solution by using RADIUS as the authentication mechanism. Accordingly, authentication using RADIUS can process greater than or equal to 250 transactions per second (tps). This in turn provides rapid and secure authentication for thousands of video media devices, such as set-top boxes 502, concurrently.

The present system/methodology thus provides but is not limited to the following benefits: 1) fast, secure authentication prevents unauthorized users from accessing video services; 2) concurrent or simultaneous authentication, on the order of thousands per second, provides all subscribers with immediate video service; 3) scalability is realized to accommodate subscriber base growth projections; and 4) improves the overall subscriber experience by providing reliable and consistent video service.

Upon reviewing the aforementioned embodiments, it would be evident to an artisan with ordinary skill in the art that said embodiments can be modified, reduced, or enhanced without departing from the scope and spirit of the claims described below. For example, while the illustrative embodiment above gives the example of concurrent or simultaneous authentication of a plurality of video media devices using RADIUS after a power outage, it is not limited to situations where a power outage has occurred, but is equally applicable for general authentication which includes, for example but is not limited to, installation of video media devices.

Moreover, the IPTV system may comprise a cluster of web servers which communicate with the plurality of video media devices and with the RADIUS. The present system and methodology also contemplates load balancing the authentication requests from the plurality of video devices among the cluster of web servers of the IPTV system prior to concurrent authentication by the RADIUS.

Other suitable modifications can be applied to the present disclosure without departing from the scope of the claims below. Accordingly, the reader is directed to the claims section for a fuller understanding of the breadth and scope of the present disclosure.

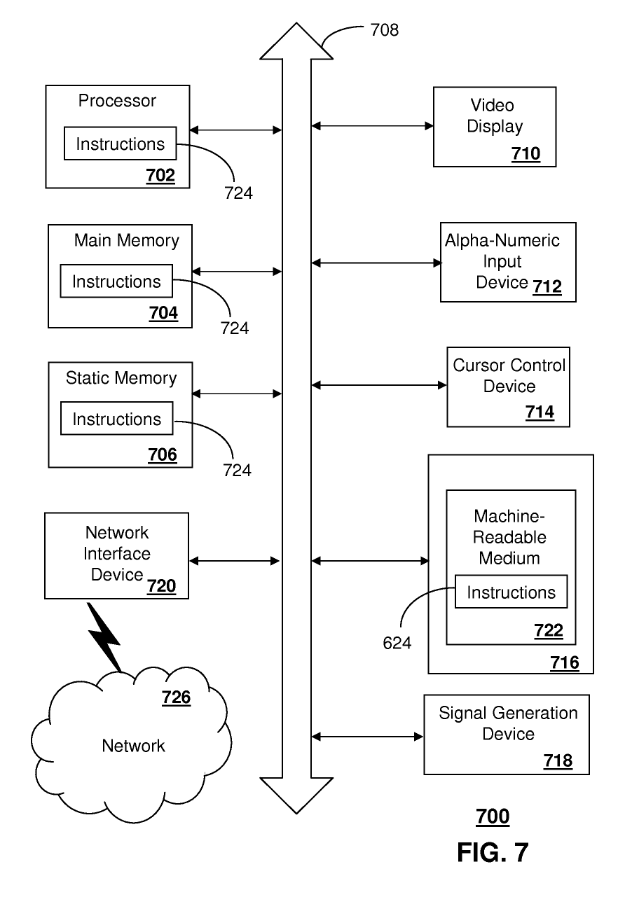

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. In a web server, a method, comprising:
requesting authentication for a plurality of video media devices operating in an interactive TV (iTV) system after a power outage has occurred in said system;
authenticating the plurality of video media devices concurrently using a remote authentication dial in user service (RADIUS); and
restoring service to the plurality of video media devices based on the concurrent authentication by the RADIUS.

2. The method of claim 1, wherein requesting authentication comprises communication with a service enablement device prior to authentication by the RADIUS.

3. The method of claim 2, wherein the service enablement device comprises a bootstrap device.

4. The method of claim 1, wherein the video media devices comprise set-top boxes.

5. The method of claim 1, wherein the iTV system comprises at least one of an Internet Protocol Television (IPTV) system, an interactive cable TV system, an interactive satellite TV system, a cellular communication system, a landline telephony communication system, or an IP Multimedia Subsystem (IMS) system.

6. The method of claim 1, wherein the web server comprises a cluster of web servers which communicate with the plurality of video media devices and with the RADIUS.

7. The method of claim 6, comprising load balancing the authentication requests from the plurality of video devices among the cluster of web servers prior to concurrent authentication by the RADIUS.

8. The method of claim 6, wherein requesting authentication comprises communication with a service enablement bootstrap device prior to communication with the cluster of web servers followed by authentication by the RADIUS.

9. The method of claim 1, wherein the authentication using the RADIUS processes greater than or equal to 250 authentication transactions per second (tps).

10. The method of claim 1, wherein the authentication using the RADIUS simultaneously authenticates thousands of video media devices.

11. A web server, comprising a controller to:
receive a request for authentication from a plurality of set-top boxes operating in an Internet Protocol Television (IPTV) system via a service enablement device;
authenticate the plurality of set-top boxes using a remote authentication dial in user service (RADIUS); and
enable service to the plurality of set-top boxes based on the authentication using the RADIUS.

12. The web server of claim 11, wherein the service enablement device comprises a bootstrap device.

13. The web server of claim 12, wherein the web server comprises a cluster of web servers, and wherein the request for authentication comprises communication with the service enablement bootstrap device prior to communication with the cluster of web servers of the IPTV system followed by authentication by the RADIUS.

14. The web server of claim 11, wherein the authentication using the RADIUS processes greater than or equal to 250 authentication transactions per second (tps).

15. The web server of claim 11, wherein the authentication using the RADIUS authenticates thousands of set-top boxes.

16. The web server of claim 11, wherein the request for authentication for the plurality of set-top boxes is generated after a power outage has occurred.

17. A remote authentication dial in user service (RADIUS), comprising a controller to:
receive requests for authentication from a web server for a plurality of video media devices operating in an interactive media system after conversion of the requests from a simple object access protocol (SOAP) to a user datagram protocol (UDP); and
authenticate the requests for the plurality of video media devices concurrently to provide completed requests, thereby enabling service to the plurality of video media devices after conversion of the completed requests from UDP to SOAP.

18. The RADIUS of claim 17, wherein the authentication processes greater than or equal to 250 authentication transactions per second (tps).

19. The RADIUS of claim 17, wherein the authentication operation authenticates thousands of video media devices.

20. The RADIUS of claim 17, wherein the video media devices comprise set-top boxes.

21. The RADIUS of claim 20, wherein the requests for authentication for the plurality of set-top boxes is generated after a power outage has occurred.

22. A set-top box (STB) operating, comprising a controller to:
send a request for authentication via at least one service enablement device and at least one web server; and
obtain authentication for the STB concurrently with other STBs using a remote authentication dial in user service (RADIUS), wherein the RADIUS enables service to the STB and the plurality of other STBs based on the concurrent authentication using the RADIUS.

23. The STB of claim 22, wherein the authentication using the RADIUS processes greater than or equal to 250 transactions per second (tps).

24. The STB of claim 22, wherein the authentication using the RADIUS simultaneously authenticates thousands of set-top boxes.

25. The STB of claim 22, wherein the request for authentication for the plurality of set-top boxes is generated after a power outage has occurred, and wherein the set-top boxes operate in an interactive television system.
